(19) United States
(12) Patent Application Publication
(10) Pub. No.: US 2004/0213657 A1
(43) Pub. Date: Oct. 28, 2004

(54) Carpet unloading apparatus

(76) Inventor: Lamar J. Bennett, Lakeland, GA (US)

Correspondence Address: Brian D. Bellamy, P.O. Box 1997, Thomasville, GA, 31799-1997, US

(21) Appl. No.: 10/820,890

(22) Filed: Apr. 8, 2004

Related U.S. Application Data
(60) Provisional application No. 60/461,102, filed on Apr. 8, 2003.

(51) Int. Cl. B60P 1/00

(52) U.S. Cl. 414/542

(57) ABSTRACT

An unloading apparatus for unloading a roll of material such as carpet from a transport vehicle comprising a support frame having a rail running lengthwise above a roll of material within the cargo bay. A trolley system is movably attached to one end of the rail for traversing along the rail toward the rear of the vehicle. A lifting device, such as a hoist cable, attaches the trolley system to a first end a mandrel tube that passes through the roll material being supported. The tube may be adjustable in length and includes a telescoping member, which is at the end attached to the lifting device. A mobile support jack is situated outside of the cargo bay for lifting and supporting the second end of the tube when removing the roll material from the vehicle. The support jack may be moved away from the vehicle while supporting the roll of material at its second end. Additionally, a mobile support pedestal or additional jack member may be provided to support the first end of the tube when detached from the trolley system. Both the support jack and support pedestal may be provided bearing members to permit the rolled material to rotate for unrolling.

### PRIORITY CLAIM

The present application claims benefit of the filing date of the U.S. provisional patent application Ser. No. 60/461,102 filed Apr. 8, 2003.

### BACKGROUND OF THE INVENTION

1. Field of the Invention

The present invention relates to an apparatus for handling carpet. More specifically, this invention relates to an apparatus for unloading a carpet roll or rolled other materials from a transport vehicle at a job site where heavy unloading equipment and lifts are generally unavailable. The carpet unloading apparatus enables one or more individuals to handle rolls of carpet without the excessive lifting and straining generally associated with such work.

2. Description of the Prior Art

Rolls of carpeting are commonly very large, bulky and heavy. Therefore, to manually handle these rolls is very strenuous, tiring and undesirable, as well as a potential cause of back injuries or muscle strain. Unfortunately, the type of heavy equipment usually associated with handling carpet rolls is generally unavailable at a job site where carpet in being installed. Thus, leaving a burdensome task to the individuals involved that has not been overcome by the numerous methodologies implemented to address carpet roll handling. In particular, none of the prior attempts satisfactorily provide for carpet roll handling at remote work sites.

U.S. Pat. No. 3,750,811 issued to Anderson discloses a carpet unloading and transporting assembly that comprises an elongate rectangular frame equipped with electric winches and cables. A support leg extending downward at each of the four corners supports this large frame. Each of these legs has a caster attached for mobility. The Anderson apparatus is placed at the rear of a transport vehicle where a cable is placed around a roll of carpet from outside the vehicle. Then, with another set of cables and a winch, the roll is lifted off the floor. The apparatus can then be rolled to another location in a warehouse carrying the carpet with it. While beneficial for its intended use, this equipment is specifically designed for a store or warehouse setting and is not suitable for relocation and use at a jobsite.

In another example, U.S. Pat. No. 2,702,139 issued to Faustine illustrates a similar apparatus to Anderson above that too is unsuitable for relocation. In yet another example, U.S. Pat. No. 4,396,166 issued to Kollman, provides an apparatus inside a closed-in cargo type trailer. This device consists of a closed-in trailer large enough to carry several rolls of carpet with a rear door through which the rolls can be pulled via an electric power winch mounted inside the trailer. Once the carpet is inside the trailer it can be suspended off the floor by a lifting mechanism mounted inside the trailer, then the end of the roll can be fed as it is unrolled through an opening in the side of the trailer long enough to allow the width of the carpet to pass through. This design allow for the carpet to be cut in lengths as needed while the remainder of the roll is suspended inside the vehicle. While this is a very impressive design, the cost factor would be so great as to render it unaffordable or impractical for many would be users.

Accordingly, a need exists for a carpet-unloading apparatus that remains with a transport vehicle so that it will be available when needed to unload a carpet roll or the like at a work site. It is also necessary that it be user-friendly, quick and easy to operate. It should also be relatively inexpensive and affordable enough for those who need it. This present invention will meet all these necessities.

### BRIEF SUMMARY OF THE INVENTION

The present invention provides for a novel and unique user-friendly carpet unloading device, part of which will be removably attached and remain inside the vehicle to which it is assigned. The other parts are set up on the outside of the vehicle for use, after which they are folded together and stored in some small area until further needed.

The apparatus of the invention is small, lightweight and can be assembled into a folding arrangement or stored in very little space in the vehicle while being transported. It is light enough to enable one person to operate. It is relatively inexpensive to manufacture which makes it very affordable. It is very safe and requires very little physical strength to unload a roll of carpet.

With the use of this present invention, an operator is able to mechanically lift a roll of carpet, remove it from the vehicle and have it resting on an elongated tube, which extends lengthwise through the center of the roll. This tube is then supported on each end by a ridged pedestal or jack stand or combination thereof. This stand will hold the roll of carpet off the floor where it can be unrolled and cut into the desired lengths.

The present invention is comprised of a framework to be securely attached to the inside of the vehicle. This framework consists of, among other things, a series of columns, or posts that extend upward from the floor to near the top of the vehicle. These columns, or posts are designed to be adjustable in length and can be adjusted to the height of the vehicle in which they are installed. The size and number of these columns are determined by the length of the overhead rail and the weight they are to support. These columns are spaced apart one from another along the side and relative to the wall of the transport vehicle. Each column has a corresponding column of like configuration directly across the vehicle and relative to the opposite wall. Each of these columns has a corresponding cross-member that attaches at the top of teach column and extends in a cross direction toward the center of the vehicle. The cross-members are also adjustable in length and may be adjusted to the width of the vehicle in which it is installed. Each of these corresponding cross-members is then attached to an upper mounting bracket at the top center of the vehicle. Thus, when all these components are connected they make up a set of supports and form a structural arch across the vehicle. This is repeated as often as necessary to support the weight that is to be moved along the top rail.

The top rail is a long rail or track suspended from the bottom center of each upper mounting bracket via a tie rod or hanger. These tie rods or hangers should be constructed in a manner that will provide for the top rail to be made ridged to the supporting framework.

A trolley is placed on the rail. This trolley should be suitable for use on this rail and sufficient to move the load suspended beneath it with a relatively minimal amount of force. A hoist sufficient to lift, hold and lower the expected load is attached to the trolley and an attaching devise is lowered down to the load.

The device of the present invention provides for an adjustable length tube with a telescoping mechanism at one end and a shaft or portion of the tube extending outward from the other while holding a roll of carpet. This tube can be coupled together or separated at approximately center ways. In the outermost section of this tube is stored a slightly smaller and shorter length of similar tube. This inside tube can be extended out in various lengths and locked in place then inserted into the other section of the outer tube and locked in place on that end. This feature allows for the tube to be adjusted to proper length corresponding to the carpet being moved. This tube, when adjusted to the proper length and locked in place can be passed lengthwise through a roll of carpet. The telescoping mechanism of the tube can then be attached to the lower end of the hoist that is attached at the top to the trolley. In one embodiment, a shaft at the outermost end of this tube may be designed to pass through a collar mounted pilot bearing located near the top of a jack. This jack is easily affixed on a stand that is also equipped with large swivel casters that provides for the stand to be easily rolled in any direction while bearing the load of a roll of carpet. These casters are also provided with a locking brake that may be applied when movement is unsuitable. A second stand is also provided that is very similar to the first. The second stand may be provided with a removable jack and include large swivel casters like the first stand. In an alternative embodiment, the second stand may have a ridged pedestal that can be raised or lowered as desired, in lieu of a jack. The carpet roll will generally roll freely about the tube. As an enhancement, the pedestal may include rollers at the top for the tube to rest on once it has been removed from the vehicle. Thus, the tube is passed length ways through a roll of carpet then attached at the innermost end to the hoist and at the outer end to the jack that is affixed to a stand equipped with casters.

Now when the hoist is raised at one end, the jack at the other end of the roll will be lifted from the surface where it lay. After the roll has been lifted it can be easily pulled in an outwardly direction. At this time the jack stand that is on casters and the overhead trolley will begin to roll, thus removing the carpet from the vehicle. When the trolley reaches the outer limit of the rail, the trolley will stop. At this time the telescoping mechanism can be released. This will allow the roll to be pulled further out until the carpet is clear of the vehicle, then by lowering the hoist the tube can be lowered onto the second stand or jack. After carpet is lowered onto the second jack, the hoist can be disconnected from the telescoping mechanism. The telescoping mechanism can now be pushed back into the tube and the vehicle removed, or, because of the casters at each end of the carpet roll, the carpet roll may be removed to a more suitable location. Because this tube is resting on rollers at one end and a bearing at the other, or alternatively, lateral supports extending from the jack stands, carpet roll or tube may be easily rotated as the carpet is pulled off the roll. The casters can also be locked in position in order to hold the stands while the carpet is unrolled.

### BRIEF DESCRIPTION OF THE DRAWINGS

FIG. 1 is a perspective view illustrating the present carpet unloading apparatus.

FIGS. 2a, 2b and 2c are side plan views illustrating the operation of the present carpet unloading apparatus.

FIGS. 3a, 3b and 3c are front plan assembly views illustrating the assembly of the support frame of the present invention.

FIG. 4a is a perspective view illustrating the assembly of the overhead support rail of the invention and trolley system.

FIG. 4b is a front side sectional view illustrating the assembly of trolley system of the present invention.

FIG. 5 is a side plan view illustrating the assembly of the carpet roll supporting tube, overhead rail, and hoist of the present invention.

FIGS. 6a, 6b and 6c are side plan assembly views illustrating the assembly of the supporting tube of the invention, including telescoping members.

FIG. 7 is a side plan view illustrating an alternative embodiment of the present carpet unloading apparatus in an operative condition in which a carpet roll has been unloaded onto a pair of jack stands.

### DETAILED DESCRIPTION OF THE INVENTION

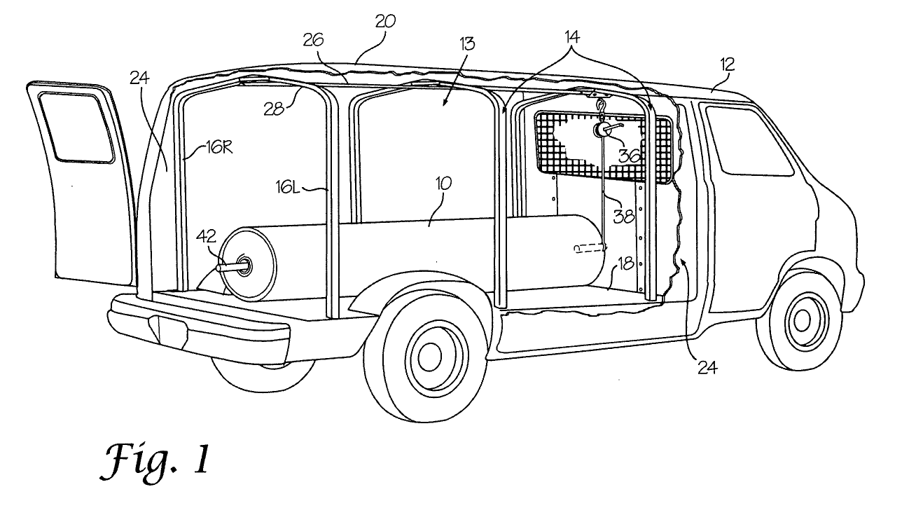

Referring now to the drawings, FIG. 1 illustrates a preferred embodiment of the present invention. A carpet unloading apparatus for unloading a roll of material such as a carpet roll 10 from a transport vehicle 12 is provided comprising a support frame structure 14, a carpet roll support tube structure 42, and external means 50 and 58 for supporting a carpet roll via the carpet roll support tube structure once the carpet roll is removed from a vehicle. The support frame structure stands within a rear cargo bay 13 of the transport vehicle 12 and supports a trolley system 34 and hoist systems 36 that traverses along an overhead rail 26 to remove a carpet roll from the transport vehicle and place the carpet roll securely on the external support means.

More particularly, a removable and independent support frame structure 14 is provided having vertically oriented columns 16 for supporting the trolley system 34 and hoist systems 36 above a carpet roll 10 situated within the rear cargo bay 13 of the transport vehicle 12. Several columns 16L are located along the left sidewall of the vehicle, and several columns 16R are located opposite left side columns along the right side wall of the vehicle. The columns 16 rest on the floor 18 of the vehicle 12 and are supported thereby, but not necessarily affixed to the vehicle. Ties or braces 17 attached from the floor, ceiling or sidewalls of the vehicle cargo bay 13 may further support the columns 16. Sufficient columns 16 are provided to ensure adequate support of the very heavy carpet rolls 10 or the like to be handled by the apparatus. The columns 16 are placed very near to the sidewalls 22, 24 of the vehicle in order to maximize the workspace provided about the carpet roll 10 stored within the rear cargo bay 13.

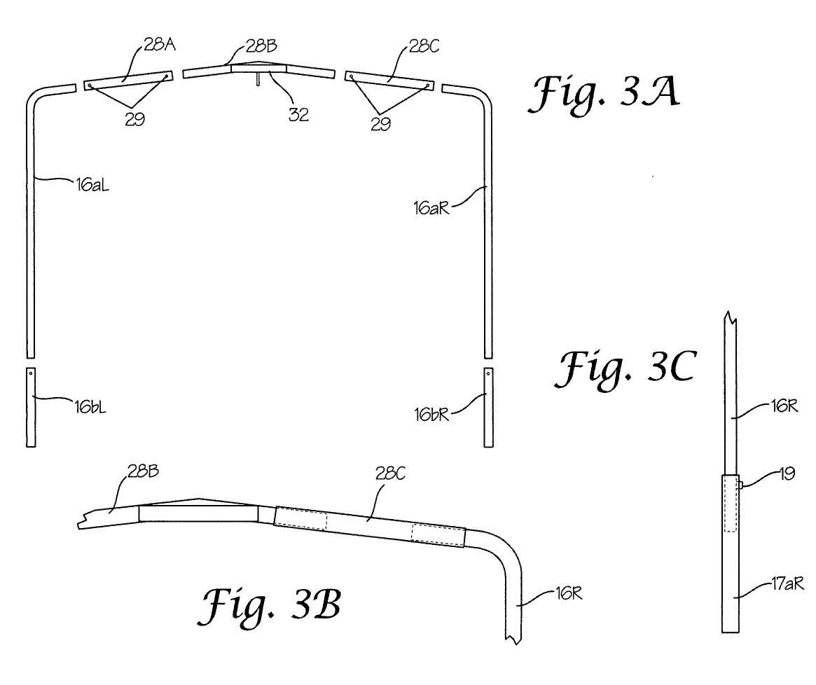

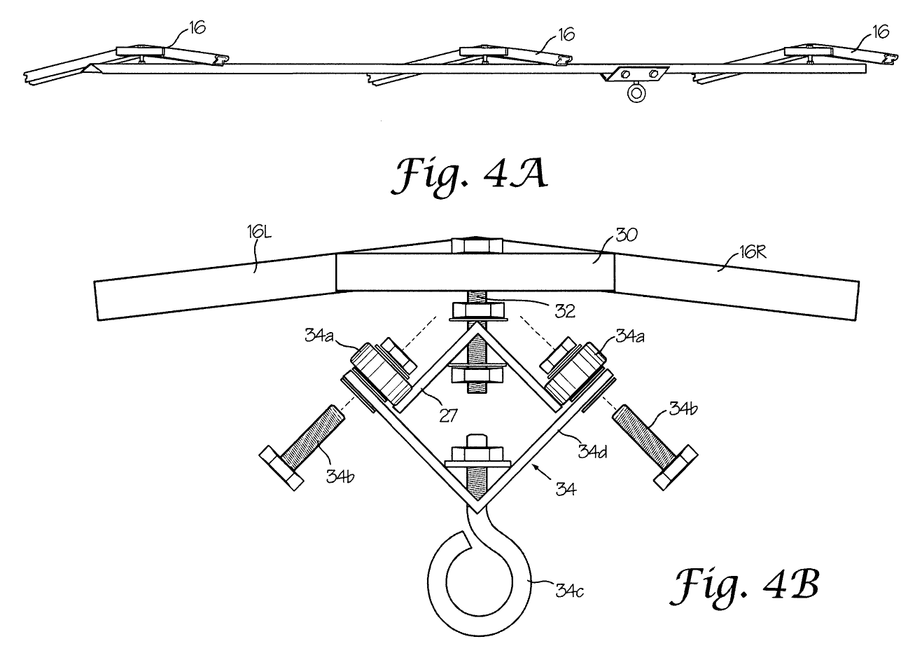

The column members 16 as shown in FIGS. 1, 3a and 3c, are adjustable for height to fit into vehicle cargo bays 13 of varying heights. In particular, the columns 16 may comprise first column members 16aR and 16aL and second column members 16bR and 16bL. First column members 16aR, 16aL may have a smaller circumference that the second column members 16bR, 16bL for insertion of first column members into the second column members. Alternatively, a lower portion of the first column members 16aR, 16aL may be swedged or have reduced diameter for insertion into second column members 16bR, 16bL. Means for fixing the position of the first column members within the second column members is provided to fix the height of the column members 16. As shown in FIG. 3c, a bolt 19 may be inserted into an aperture in each second column member 16bR, 16bL and tightened to bear against the respective first column member 16aR, 16aL contained within the second column member such that the first column member will not slide and will remain in a fixed position.

The support frame structure 14 includes cross-members 28 that span from the left column members 16L to the right column members 16R to provide support above the carpet roll 10. The columns 16 may have angled upper portions 21 to intersect and connect to the cross-members 28. In one embodiment as illustrated in FIGS. 3a and 3b, the cross-members 28 comprise the angled portion 21 of the columns 16, a pair of intermediate adjusting members 28a, 28b and a center connecting member 28c, which may be slightly arched to fit the contour of a vehicle cargo bay 13, increase vertical space available, and align each intermediate member 28a, 28b with the center connecting member 28c and angled portions 21 of the columns 16. Each intermediate adjusting member 28a, 28b connects the angled portion 21 of each respective column 16 to the center connecting member 28c such that a single horizontal span across the cargo bay 13 of the vehicle 12 is created. The connection of the intermediate members 28a, 28b may be accomplished by providing a tubular receptacle on each end of the intermediate members that receives the respective ends of the columns 16 or center connecting member 28c. Changing the amount of the column 16 or center connecting member 28c that is inserted into the intermediate member receptacle may adjust the length of the span. Bolts 29 or affixing devices are provided for securing the intermediate members, and, thereby, defining the length of the cross-members 28.

The cross-members 28 support a rail 26, which runs lengthwise along the ceiling of the rear cargo bay 13 of the transport vehicle 12. The depicted rail 26 comprises a long narrow angle iron situated with the ends 27 of the angle iron pointing downwards. The rail 26 is attached to the cross-members 28 by a tie rod 32 that hangs from the center of the cross-members, and a nut or other method is used to attach the rail to tie rod. The tie rod 32 provides for adequate spacing between the cross-members 28 and rail 26 for the provision of a trolley system 34.

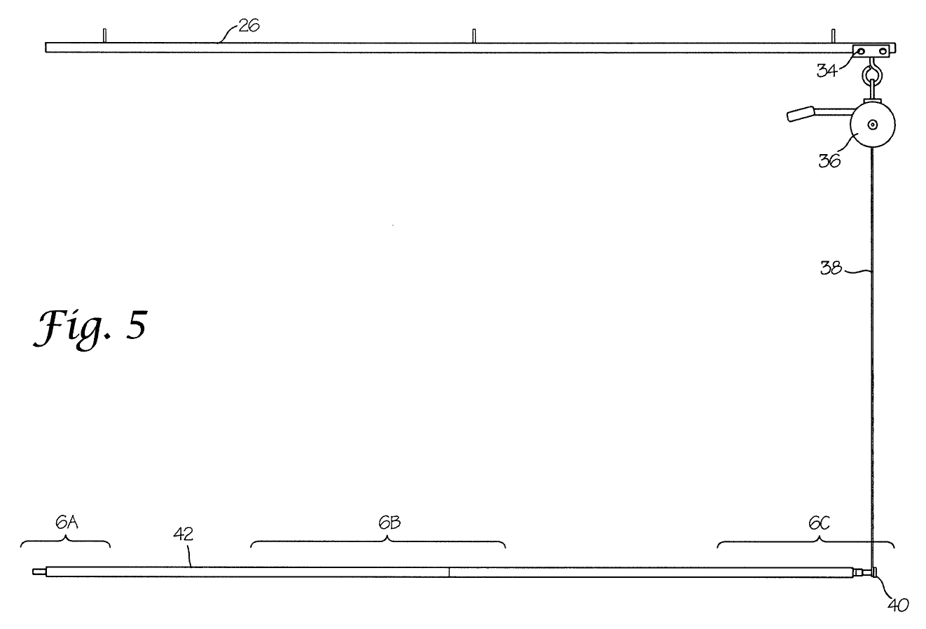

As shown in FIG. 5, the trolley system 34 may run along the lengthwise rail 26 via bearing wheels 34a. An attaching device 34b such as a bolt and nut combination attaches each bearing wheel 34a above the ends 27 of the angle iron of the rail 26 and the bolt may provide a shaft for the bearing wheels to rotate about. The trolley system 34 further includes a short angle iron member 34d with the ends pointing upwards for attachment of the bearing wheels 34a above the rail 26. The short angle iron member 34d is suspended below the rail 26 by the bearing wheels 34a and provides a support for a hoist and pulley system 36a that may be attached to the short angle iron by an eye bolt 34c attached thereto. The bearing wheels 34a roll along the upper edge of the rail 26 and traverse the rail for movement of a supported carpet roll 10 or the like. Thus, the trolley system 34 may be attached to the end of the carpet roll 10 via a suitable device such as a cable 38 with hoist and pulley 36a. The trolley 34 would support the carpet roll 10 at the end closest to the inward portion of the vehicle's rear cargo bay 13. When the carpet roll 10 is removed from the vehicle's rear cargo bay 13, the trolley system 34 allows the carpet roll to exit the rear of the vehicle 12 while the trolley moves toward the rear of the vehicle along the rail 26. A hook or attaching device 40 connects the cable 38 to the end of tube that supports the carpet roll.

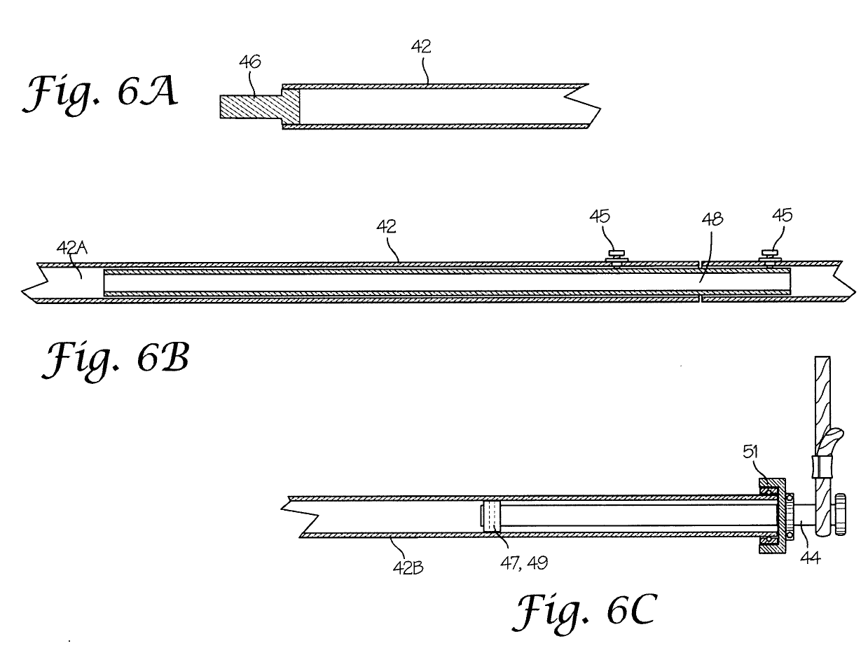

The elongate tube 42 shown in FIGS. 5 and 6a, 6b and 6c may comprise a first square tube member 42a and second square tube member 42b having a connecting tube member 48 between them, a telescoping tube member 44, and a shaft 46. The connecting member 48 may be received by the respective open ends of the first and second square tube members 42a, 42b and secured between the tube members by set screws 45 or other securing mechanism such as spring loaded lock buttons. By loosening the setscrews 45, the length of the elongate tube 42 may be varied according to the length of carpet roll 10 being transported and handled, such as 12 ft or 15 ft.

At the end of the elongate tube 42 that is positioned toward the inward portion of the vehicle's rear cargo bay 13, the elongate tube is provided a telescoping tube member 44. The telescoping tube member 44 may be housed partially within the walls of the second square tube member 42b and extend from the end of the second square tube member to increase the overall length of the tube 42. A first bearing member 47 at the inward end of the telescoping tube member 44 promotes the efficient telescoping of the telescoping tube member. The first bearing member 47 as shown includes a bearing wheel 49 rotationally attached to the inward end of the telescoping tube member 44 and contained within the square tube member 42b. The bearing wheel 49 is situated between the inside corners of the square tube member 42b, which creates a track for longitudinal movement of the wheel during the telescoping function of the telescoping tube member 44, while limiting the latitudinal movement of the wheel. A second bearing member 51 at the end of the tube 42 and situated about the telescoping tube member 44 further supports and promotes efficient telescoping of the telescoping tube member. The second bearing member 51 is shown at the end of the tube 42 and is attached thereto. The telescoping tube member 44 rolls along the second bearing member when extended to telescope from the end of the tube.

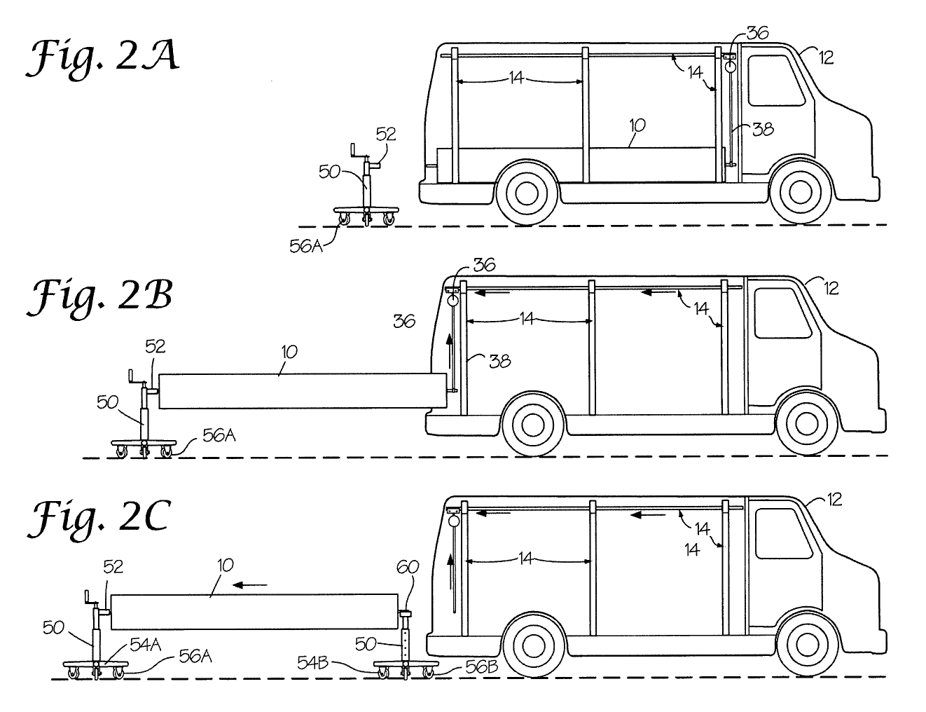

The carpet roll 10 is removed from the vehicle's rear cargo bay 13 using the trolley system 34. Before removal of the carpet roll 10, a jack 50 supports the outward end of the tube 42. One preferred jack 50 as shown in FIG. 2 includes a collar with pilot bearing 52. The shaft 46 extending from the outward end of the tube 42 is inserted into the collar 52. The shaft 46 may rotate as a result of the supporting pilot bearing 52.

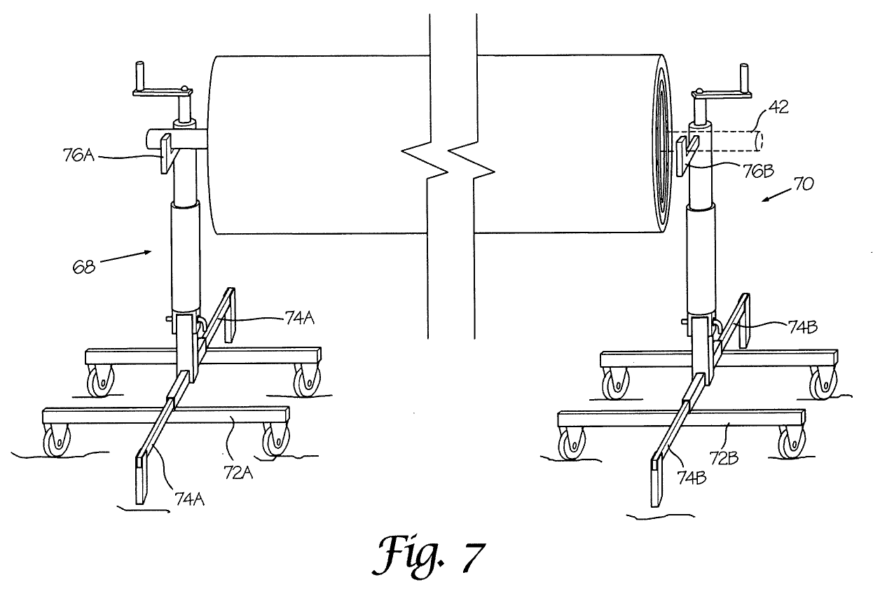

FIG. 7 shows an alternative arrangement of a first jack 68 and second jack 70 in which the jacks include supports 76A and 76B extending laterally to a side of the jacks for supporting the tube 42 that the carpet roll is on. In this arrangement, the jacks 68 and 70 support the tube to the side and offset from the center of the jacks.

Once the jack 50 or 68 supports the outward end of the tube 42, the jack 50 is moved away from the rear of the vehicle 12, thus moving the carpet roll 10 out of the vehicle. The carpet roll 10, which is supported at the inward end of the tube 42 by the moving trolley system 34, does not completely exit the vehicle 12 because the trolley may only traverse to the end of the rail 26. Once at the end of the rail 26, a provided release mechanism, such as a latch pin, is released to permit telescoping of the telescoping tube member 44 to extend the tube and further remove the carpet roll 10 from the rear of the vehicle 12. The hook or attaching device 40, which connects the cable to the end of tube 42 to support the carpet roll 10, attaches to the telescoping tube member 44. Thus, the carpet roll 10 may be separated from the vehicle 12 via the telescoping tube member 44, and, the tube 42 then disconnected from hoist cable 38.

After disconnecting the tube 42 from the hoist cable 38, the user may rest the end of the carpet roll 10 opposite the end supported by the jack 50 on an external pedestal 58. The carpet roll 10 supported by the jack 50 and pedestal 58 may be positioned for using the roll of carpet. Rolling stands 54A and 54B (or 72A and 72B) along with several casters 56a and 56b that are situated beneath the jack and pedestal (or combination of jacks as in FIG. 7) permit movement of the supported carpet roll to a suitable work location. Once situated, stabilizers 74A and 74B may be provided to extend from each side of the stands 72A and 72B. These stabilizers may be arranged to telescope from the center beam of the stands and turned up to retract into the center beam when not in use. A locking mechanism may be arranged between the stabilizers and stand to affix the stabilizers into the telescoped or retracted positions. The pedestal 58 may have rollers 60 that support the end of the tube 42. The combination of the pilot bearing 52 supporting the shaft 46 at one end of the tube 42 and the rollers 60 supporting the telescoping tube member 44 at the other end of the tube permit the unrolling of the carpet roll 10 after it has been removed completely from the vehicle 12. Alternatively, the inward end of the tube 42 could remain attached to the vehicle 12. A bearing member may be provided on the telescoping tube member 44 to permit the tube 42 to rotate while attached to the vehicle 12 via cable 38 or other means, thus permitting unrolling of the carpet. In another embodiment shown in FIG. 7, each end of the tube 42 may be supported by the brackets 76A and 76B. Thereby, the roll of carpet may roll freely about the tube 42.

It should be apparent to those skilled in the art that modifications and variations can be made to the embodiments of the invention described herein without departing from the scope and spirit of the invention as set forth in the claims and their equivalents.

I claim:

1. An unloading assembly for handling a roll of material comprising:
a support frame;
an elongated rail attached to the support frame and running longitudinally above a holding area for holding the roll of material;
a trolley system attached to the rail and arranged to traverse lengthwise along the rail;
a lifting device attached to the trolley system;
a tube having a telescoping member terminating in a first end attachable to the lifting device, and the tube terminating in a second end; and
a support situated outside of the holding area that couples to the second end of the tube for lifting and supporting the second end of the tube.

2. An unloading assembly for handling a roll of material as in claim 1 in which the support frame includes a plurality of column members, including opposing column members defining a workspace therebetween lengthwise along the holding area, the column members secured to the holding area by a plurality of brace members, the column members comprising first column members and second column members coupled together and adjustable to vary the support frame's height.

3. An unloading assembly for handling a roll of material as in claim 1 in which the support frame includes a plurality of column members and a plurality of cross-members spanning between the column members and defining a workspace below the cross-members and between the column members, each of the cross-members include intermediate members and a center connecting member coupled together and adjustable to vary the support frame's width.

4. An unloading assembly for handling a roll of material as in claim 1 in which the elongated rail comprises a long narrow angle member with it's apex oriented upward and it's arms oriented downward, the rail adjoining the support frame by a plurality of tie rods providing clearance between the rail and support frame for traverse of the trolley system.

5. An unloading assembly for handling a roll of material as in claim 1 in which the trolley system includes a short angle member with it's arms oriented upward, a pair of bearing wheels connected to the arms of the short angle member and resting on the rail such that the bearing wheels traverse lengthwise along the rail.
a support situated outside of the holding area for lifting and supporting the second end of the tube.

6. An unloading assembly for handling a roll of material as in claim 1 in which the support situated outside of the holding area includes a jack in combination with a support arm extending from the jack for holding the second end of the tube, the jack being supported by a stand having castors, and the stand having one or more stabilizing legs telescopically extending from the stand while operable and capable of being stored within the stand while inoperable.

7. A system for unloading a carpet roll from a transport vehicle cargo bay comprising:
a support means having a length greater than the width thereof and having a plurality of cross members, said support means situated within the vehicle cargo bay and having means for mounting a longitudinally mobile hoist means;
a mandrel means having a telescoping member extending from a first end of the mandrel, said telescoping member having means to releasable engage the hoist means
a first rolling jack means situated outside of the vehicle cargo bay for supporting a second end of the mandrel during unloading of the carpet roll;
a means for moving the hoist means rearward within the cargo bay while the first rolling jack means is moved away from the vehicle cargo bay; and
a second rolling jack means for supporting the first end of the mandrel or telescoping member upon release of the telescoping member from engagement with the hoist means.

8. A system for unloading a carpet roll from a transport vehicle cargo bay as in claim 7 in which the support means is removable and independent of the vehicle cargo bay.
